(19) United States
(12) Patent Application Publication
(10) Pub. No.: US 2002/0051139 A1
(43) Pub. Date: May 2, 2002

(54) Printer and method of controlling printer

(76) Inventors: Tatsuro Akabane, Ibaraki (JP); Seiji Kageyama, Ibaraki (JP); Tadayoshi Iwai, Tokyo (JP)

Correspondence Address: McGinn & Gibb, PLLC, 8321 Old Courthouse Road, Suite 200, Vienna, VA, 22182-3817, US

(21) Appl. No.: 09/983,985

(22) Filed: Oct. 26, 2001

(30) Foreign Application Priority Data
Oct. 27, 2000 (JP) P. 2000-328003

(51) Int. Cl. G06F 15/00

(52) U.S. Cl. 358/1.2

(57) ABSTRACT

In a printer which interprets a PDL document, develops the PDL document into dot image, and prints the dot image, a PDL document as input is transferred to an interpreter part, the interpreter part interprets the PDL document and develops the PDL document into a dot image whose size is equal to the document size, and transfers the dot image to a laid-out control part, the laid-out control part converts a size of the dot image to a designated sheet size and transfers to an output control part, the output control part transfers the dot image to a printer engine, and the printer engine prints the dot image on a sheet.

### BACKGROUND OF THE INVENTION

1. Field of the Invention

The present invention relates to a printer, and more particularly to that capable of outputting various forms of prints for the purpose of bookbinding, and a method of controlling the printer.

2. Description of the Related Art

In the conventional printer, the paper size of a document is equal to the size of dot image generated. In printing, it is impossible to change the size of the dot image to a desired one. The printing position is fixed, and the dot image is printed at the central part of the printing sheet.

A conventional printer is incapable of changing the size of the dot image, and must use a printing sheet whose size is equal to that of an original document. Further, the changing of the printing position is also impossible. Accordingly, the printing position must be fixed in printing.

Additionally, where a printing sheet of extra size is used for printing, the printed sheet must be cut out at its four sides.

### SUMMARY OF THE INVENTION

Accordingly, an object of the present invention is to provide a printing system or printer in which printing sheets each having a size different from that of an original document maybe used, and an original document maybe printed at a desired location on a printing sheet, whereby improvement is achieved on the convenience and ergonomic of the printer.

To achieve the above object, the present invention is implemented as follows.

A printer constructed according to the present invention is comprised of an interpreter part, a laid-out control part, an output control part, and a printer engine.

In a printer which interprets a PDL document, develops the PDL document into dot image, and prints the dot image, a PDL document as input is transferred to an interpreter part, the interpreter part interprets the PDL document and develops the PDL document into a dot image whose size is equal to the document size, and transfers the dot image to a laid-out control part, the laid-out control part converts a size of the dot image to a designated sheet size and transfers to an output control part, the output control part transfers the dot image to a printer engine, and the printer engine prints the dot image on a sheet.

In the printer, by an instruction for designating a print position, the laid-out control part converts the size and position of the dot image developed by the interpreter part, to those of the dot image of the designated sheet size, and transfers the converted one to an output control part and the output control part sends the dot image to the printer engine, whereby the printer engine prints the dot image to a desired position on a printing sheet.

In the printer, such a printed sheet as to generate a final size of a document is produced in a simple manner that, by instructing a printing position to position the dot image to one of the four sides of the printing sheet, the laid-out control part shifts the dot image in position, and the resultant sheet is cut out at the three sides of the printed sheet.

In the printer, such a printed sheet as to generate a final size of a document is produced in a simple manner that, by instructing a printing position to position the dot image to one of the four sides of the printing sheet, the laid-out control part shifts the dot image, and further shifts the dot image by an adjustment shift by designating the adjustment shift, and the resultant sheet is cut out at the three sides of the printed sheet.

In the printer, such a printed sheet as to generate two final sizes of documents is produced in a simple manner that an identical document is instructed to be laid out at two locations on a printing sheet, and the resultant printed sheet is cut out along the center line thereof.

In the printer, such a printed sheet as to generate two final sizes of documents is produced in a simple manner that the laid-out control part shifts a dot image with respect to one half part of a printing sheet by giving an instruction to lay out the document at two locations on a printing sheet and by instructing a printing position to position the dot image to one of the four sides of the printing sheet, the laid-out control part applies a similar process to the other half part thereof, the printed sheet is cut out along the center line and resultant sheets are superimposed one on the other, and the those printed sheets are cut out at the three sides thereof.

In the printer, such a printed sheet as to generate two final sizes of documents is produced in a simple manner that the laid-out control part shifts a dot image with respect to one half part of a printing sheet by giving an instruction to lay out the document at two locations on a printing sheet and by instructing a printing position to position the dot image to one of the four sides of the printing sheet, the laid-out control part further shifts the dot image by a quantity of an adjustment shift by designating the adjustment shift with respect to the one half part of the printing sheet, the laid-out control part applies a similar process to the other half part thereof, the printed sheet is cut out along the center line and resultant sheets are superimposed one on the other, and the those printed sheets are cut out at the three sides thereof.

### BRIEF DESCRIPTION OF THE DRAWINGS

FIG. 1 is a block diagram showing an overall printing system, which is constructed according to the present invention.

FIG. 2 is a diagram showing the detail of printing system when the system converts a PDL document.

FIG. 3 is a diagram showing a conventional procedure for printing a PDL document on a printing sheet having the same size as of the document.

FIG. 4 is a diagram showing a procedure, which is constructed according to the invention, for printing a PDL document on a printing sheet whose size is different from that of the document.

FIG. 5 is a diagram showing a procedure, which is constructed according to the invention, for printing a PDL document on a desired location on a printing sheet whose size is different from that of the PDL document.

FIG. 6 is a diagram showing a conventional procedure in which a PDL document of a relatively large size is formed, and printed on a printing sheet of that size, and the output printed document is cut out into the printed document of an intended size.

FIG. 7 is a diagram showing a procedure for generating an intended size of a printed sheet by cutting three sides of the printed sheet, which the procedure is constructed according to the invention.

FIG. 8 is a diagram showing a conventional procedure to form a PDL document with a register marks, to print it, and to trim a printed sheet, by cutting, so as to have an intended size.

FIG. 9 is a diagram showing a procedure for generating an intended size of a printing sheet by cutting the printing sheet at three sides, which the procedure is constructed according to the invention.

FIG. 10 is a diagram showing a procedure in which a document laid out at two locations on a printing sheet, to thereby generating two intended sizes of the document, which the procedure is constructed according to the invention.

FIG. 11 is a diagram showing a procedure in which a document with register marks laid out at two locations on a printing sheet, to thereby generating two intended sizes of the document, which the procedure is constructed according to the invention.

FIG. 12 is a table showing exemplarily of print instruction contents.

FIG. 13 is a diagram showing an example of the printing in which the image data of one page is output to one printing sheet.

FIG. 14 is a diagram showing an example of the double printing in which the image of one page is output to two locations on a single printing sheet.

FIG. 15 is a diagram showing an example of the printing in which a B5 size document is printed in the form of an A4 size.

FIG. 16 is a diagram showing a dot image in which the left half part of the image is turned by 180°, and the right and left parts of the image are shifted toward the center of the image.

FIG. 17 is a diagram showing a dot image in which the right half part of the image is turned by 180°, and it is shifted to the right.

FIG. 18 is a diagram showing a printing system in which a dot image is written over a central part of another dot image whose size is different from that of the former.

FIG. 19 is a diagram showing an example another printing system in which a dot image is written over a left side part of another dot image whose size is different from that of the former.

FIG. 20 is a diagram showing a double print in which the image data of one page is output to two locations on a printing sheet.

FIG. 21 is a diagram showing a book having an index label.

FIG. 22 is a diagram showing an example of a print inhibiting area.

FIG. 23 is a diagram showing an example of a printed sheet with an index label printed thereon.

FIG. 24 is a diagram showing an example of a printed sheet on which an index label printed is imperfect in shape because of presence of the print inhibiting area.

### DETAILED DESCRIPTION OF THE PRESENT INVENTION

An overall printing system using a printer, which is constructed according to the present invention, will be described with reference to FIG. 1.

The printing system is made up of a network 400, a second computer 320 connected to the network 400, a printer 100, and a first computer 310 connected to the printer 100. The printer 100 includes a printer controller 200 for controlling the printer 100, and a printer engine 500 for performing a printing operation. A function of the printer 100 when it is directly connected to the first computer 310 is equal to its function when it is connected to the second computer 320 through the network 400.

A first embodiment of the invention will be described in detail.

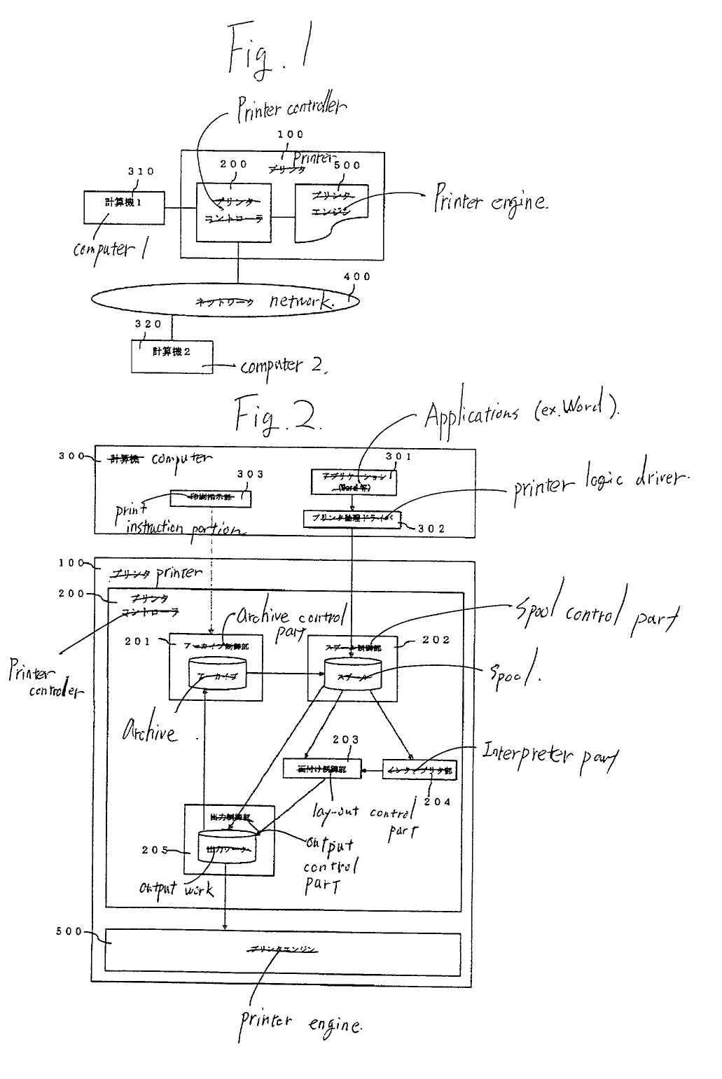

A configuration of the printer 100 will first be described with reference to FIG. 2. The printer 100 includes the printer controller 200 and the printer engine 500. The printer controller 200 further includes an archive control part 201, a spool control part 202, a laid-out control part 203, an interpreter part 204, and an output control part 205.

A print job spooled is discriminated by the spool control part 202. If it is laid out dot image, it is transferred to the output control part 205. If it is PDL (Page Description Language) data, it is transferred to the interpreter part 204. The interpreter part 204 interprets the PDL data, and then transfers the dot image to the laid-out control part 203. The laid-out control part 203 generates dot image data as indicated by instructions, e.g., print position and printing sheet, and transfers the dot image to the output control part 205. The output control part 205 transfers the received dot image to the printer engine 500 or the archive control part 201 in accordance with instructions, e.g., printing, and storing.

Exemplar instruction contents will be described in detail with reference to FIG. 12. The instruction items are print mode 1400, number-of-sheets 1403 to be printed, paper size 1404, paper feeder 1405, paper discharge portion 1406, output type 1407, printing position 1408, specific printing position 1409, adjustment shift 1410, and both-side print 1411.

The print mode 1400 consists of printing 1401 and storing 1402. The printing 1401 designates transfer or non-transfer of it to the printer engine 500. The storing 1402 designates transfer or non-transfer of the output from the output control part 205 to the archive control part 201. The number-of-sheets 1403 designates the number of sheets to be printed. The paper size 1404 designates a type of sheet to be used for printing. The paper feeder 1405 selectively designates a sheet storing device of those provided in the printer 100. The paper discharge portion 1406 selectively designates a printed sheet storing device of those provided in the printer 100. The output type 1407 consists of standard print 1412 and both-side print 1413.

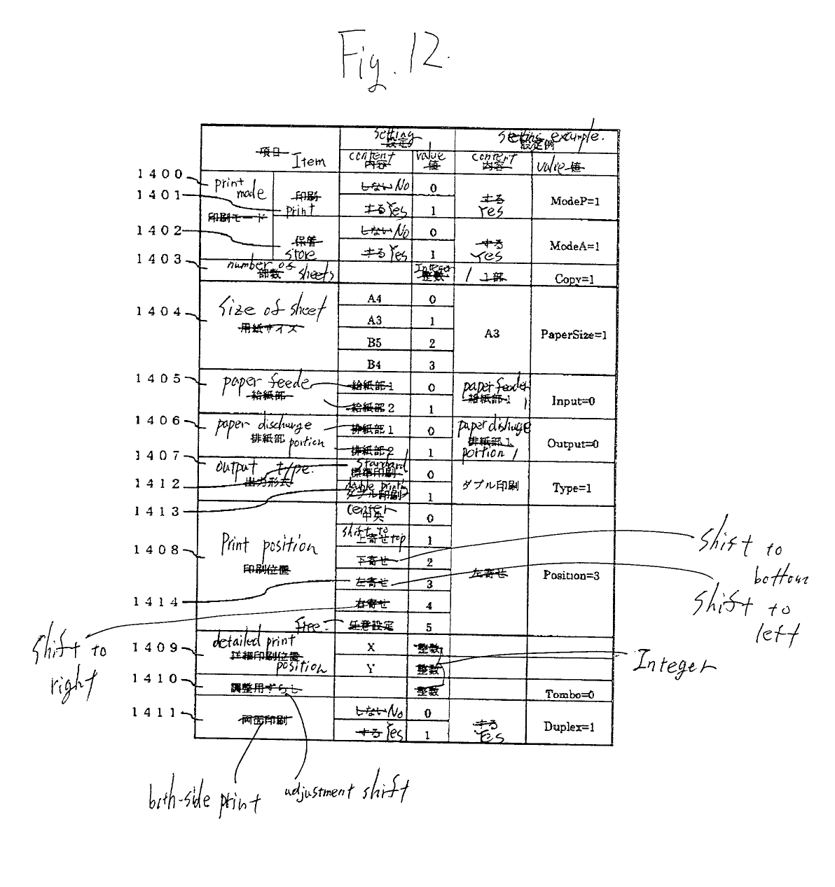

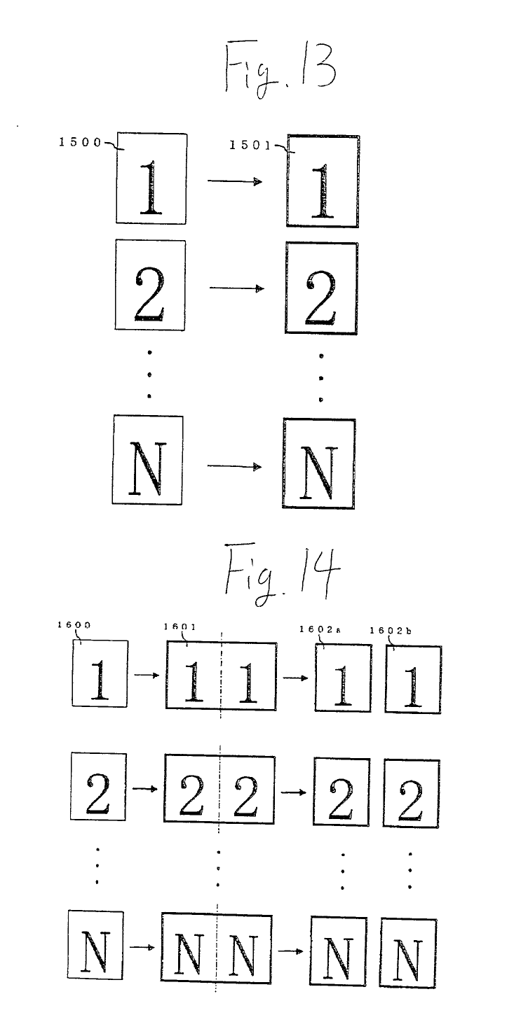

The standard print 1412 will be described with reference to FIG. 13. It is a standard output type for outputting a drawing image 1500 of one page of the PDL document is output to a printing sheet 1501. The both-side print 1413 will be described with reference to FIG. 14. This is also an output type in which two identical drawing images 1600, each of which consists of one page of the PDL document, are arranged side by side on a printing sheet 1601. The resultant sheet is cut out along its center line into printed sheets 1602a and 1602b each as such a standard printed sheet that a PDL document of one page is output to a printing sheet of one page. The printing position 1408 sets a position at which a PDL document is located on a printing sheet to be used. The specific printing position 1409 finely positions the PDL document in an appropriate unit, e.g., mm, when “free” is selected by the printing position 1408. The adjustment shift 1410 sets a further shift in an appropriate unit, e.g., mm, from a position of the PDL document as set by the printing position 1408, in order to erase register marks on the left end of the printing sheet. The both-side print 1411 designates whether or not both-side print is used.

A command for designating a print position is transferred from the computer 310 or 320 to the printer. If required, the command for designating a print position may be entered from an operator panel (not shown) provided on the printer 100.

A procedure of a first printing system for printing a PDL document on a printing sheet will be described. FIG. 3 is a diagram showing a conventional procedure for printing a PDL document on a printing sheet having the same size as of the document. The PDL document 600 is developed into the dot image 601 by the interpreter. Then, the dot image is printed on a printing sheet 602, to generate a printed sheet 603. Thus, the conventional procedural technique manages the PDL document and paper sizes such that those sizes are equal to each other, and outputs the dot image generated by the interpreter, as intact. For this reason, it is impossible to output the dot image to a printing sheet of desired size, which is different from the size of the PDL document.

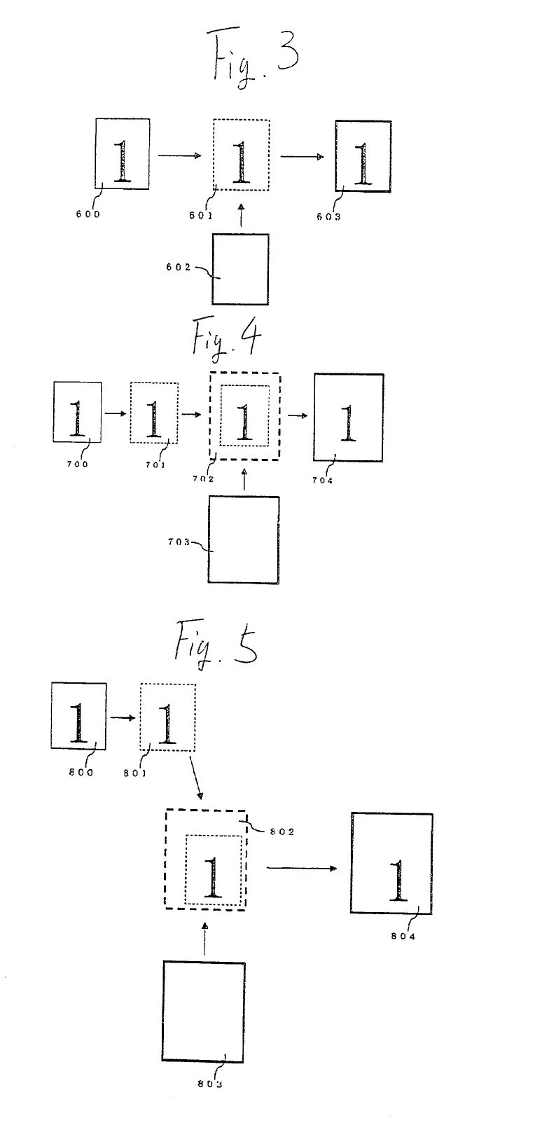

FIG. 4 is a diagram showing a procedure, which is constructed according to the invention, for printing a PDL document on a printing sheet whose size is different from that of the document. The PDL document 700 is developed into dot image 701 by the interpreter, transferred to the laid-out control part 203, and converted into dot image of the paper size as designated by the paper size 1404 shown in FIG. 12.

FIG. 18 is an explanatory diagram for explaining an example where an image 3010 of 8 dots×7 dots is converted into an another image 3000 of 12 dots×11 dots, whereby an image 3020 of 12 dots×11 dots is generated anew. In this instance, bits of the image 3010 are written over the bits of the central part of the image 3000 stored in the memory. The dot image 702 generated by the laid-out control part 203 is transferred to the output control part 205, and printed on the printing sheet 703 by the printer engine 500, to thereby generate a printed sheet 704. Thus, in the invention, the PDL document size and the sizes of the printing sheets output are separately managed. Accordingly, the PDL document may be output to a printing sheet of a desired size. With this feature, the PDL document may be printed not only on a printing sheet whose size is equal to that of the document, but also on a cheap substitute.

A procedure of a second printing system for printing a PDL document on a desired location on a printing sheet whose size is different from that of the PDL document, will be described. As described above, the conventional procedural technique manages the PDL document and paper sizes such that those sizes are equal to each other, and outputs the dot image generated by the interpreter, as intact. For this reason, the technique can not output the dot image to a printing sheet of a desired size, and also to a desired location on the sheet.

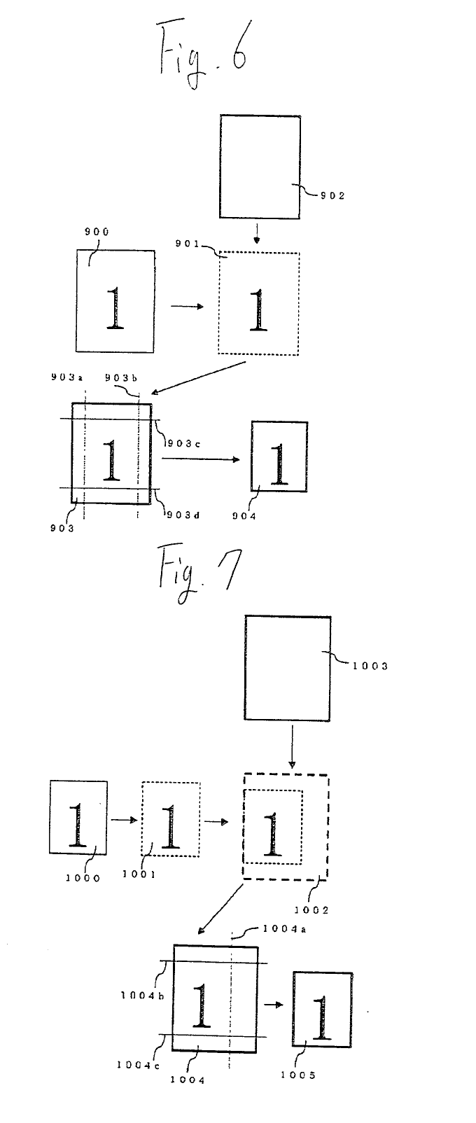

FIG. 5 is a diagram showing a procedure, which is constructed according to the invention, for printing a PDL document on a desired location on a printing sheet whose size is different from that of the PDL document. The PDL document 800 is developed into dot image 801 by the interpreter, transferred to the laid-out control part 203, and converted into dot image, which has the paper size as designated by the paper size 1404 shown in FIG. 12, and is to be positioned at a location as designated by the printing position 1408.

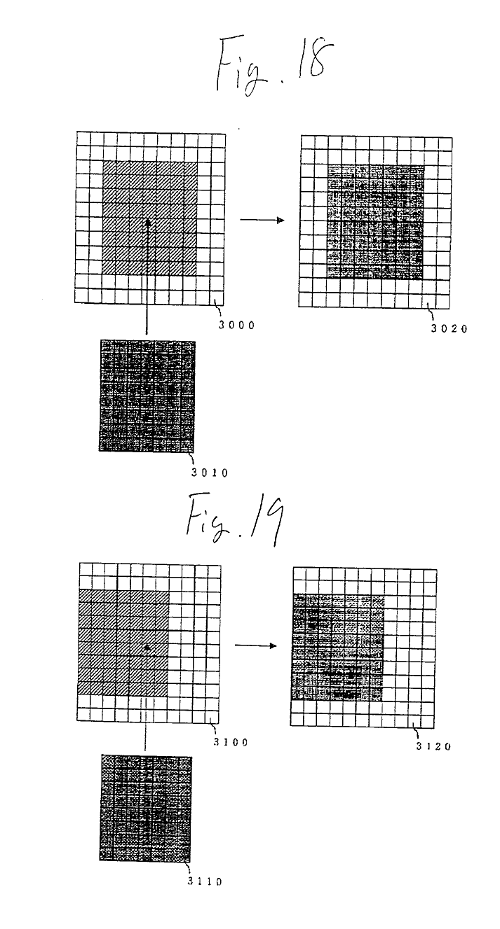

FIG. 19 is an explanatory diagram for explaining an example where an image 3110 of 8 dots×7 dots is converted into an another image 3100 of 12 dots×11 dots, whereby an image 3120 of 12 dots×11 dots is generated anew. In this instance, bits of the image 3110 are written over the bits of the left end part of the image 3100 stored in the memory. The dot image 802 generated by the laid-out control part 203 is transferred to the output control part 205, and printed on a printing sheet 803 by the printer engine 500, to thereby generate a printed sheet 804. Thus, in the invention, the PDL document size and the sizes of printing sheets output are managed separately. Accordingly, the PDL document may be output to a printing sheet of a desired size and a desired location of the sheet. Therefore, the PDL document may be printed on a cheap substitute for the regular printing sheet of paper.

A procedure of a third printing system in which a PDL document is aligned with one of four sides of a printing sheet and printed on the sheet, and then the remaining three sides of the sheet are cut out to generate a final size of a printed sheet, will be described.

FIG. 6 is a diagram showing a conventional procedure in which a PDL document of a relatively large size is formed, and printed on a printing sheet of that size, and the output printed sheet are cut out at its four sides to generate a final size of the printed sheet. A PDL document 900 whose size is equal to that of a printing sheet to be used is formed, and developed into dot image 901 by the interpreter. The data is printed on a printing sheet 902, to thereby generate a printed sheet 903. The four sides of the generated printed sheet 903 are cut out along cut lines 903a to 903d by a cutting machine or paper cutter (not shown), thereby generating a final size 904 of the sheet. Thus, the conventional procedural technique manages the PDL document and paper sizes such that the size of the former is equal to that of the latter, and outputs the dot image generated by the interpreter, as intact. Accordingly, the technique can not output the dot image to a printing sheet of a desired size and a desired location on the sheet. Therefore, it is necessary to output the PDL document of the final size to the central part of the sheet, and to cut out the four sides of the printed sheet.

FIG. 7 is a diagram showing a procedure for generating a final size of a printed sheet by cutting three sides of the printed sheet, which the procedure is constructed according to the invention. The PDL document 1000 of the final size is developed into dot image 1001 by the interpreter, transferred to the laid-out control part 203, and converted into dot image of the paper size as designated by the paper size 1404, and a location designated by printing position 1408, as shown in FIG. 12 and described above. The converted dot image 1002 is transferred to the output control part 205, and printed on a printing sheet 1003 by the printer engine 500, to thereby produce a printed sheet 1004. The three sides of the generated printed sheet 1004 are cut out along cut lines 1004a to 1004c by a cutting machine, thereby generating a final size 1005 of the sheet. Thus, in the invention, the PDL document size and the sizes of printing sheets output are separately managed. Accordingly, a final size of the printed sheet may be generated in such a simple manner that the PDL document is output to a desired location on a printing sheet of a desired size, while using dot-image converting means, and the resultant printed sheet is cut out at the three sides thereof. Accordingly, its processing time is reduced. Now, an index label will be described. A mark as designated by numeral 6010 in FIG. 21 is used for indicating a chapter in a book or dictionary. This mark is the index label.

In a printer engine system of a printer, e.g., laser printer, a print-inhibiting area 7010, as shown FIG. 22, surrounds a printing sheet 7000. No printing is permitted in the print-inhibiting area 7010.

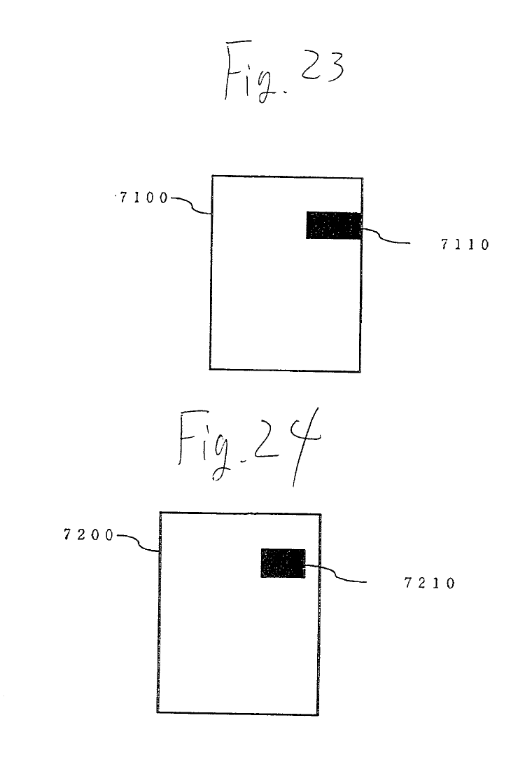

As shown in FIG. 23, it is desired to print in such a fashion that one end of an index label 7110 is positioned at one side of the printing sheet 7100. The index label, when printed, takes a form as shown in FIG. 24, viz., a part of the index label is cut out, because of presence of the print-inhibiting area. The laid-out process of the invention is able to produce a printed sheet, which may be cut out at three sides. Accordingly, the invention is able to generate a printed sheet in which the index label is printed in a state that it is positioned at one side of the printing sheet, and to print it. Further, generally, the invention is able to generate a printed sheet not having a print-inhibiting area, and print it.

Description will be given about a fourth printing system in which a PDL document is positioned at one of four sides of a printing sheet and further shifted by an adjustment shift, and in this state it is printed, and then the remaining three sides of a printed sheet are cut out to generate a final size of the document.

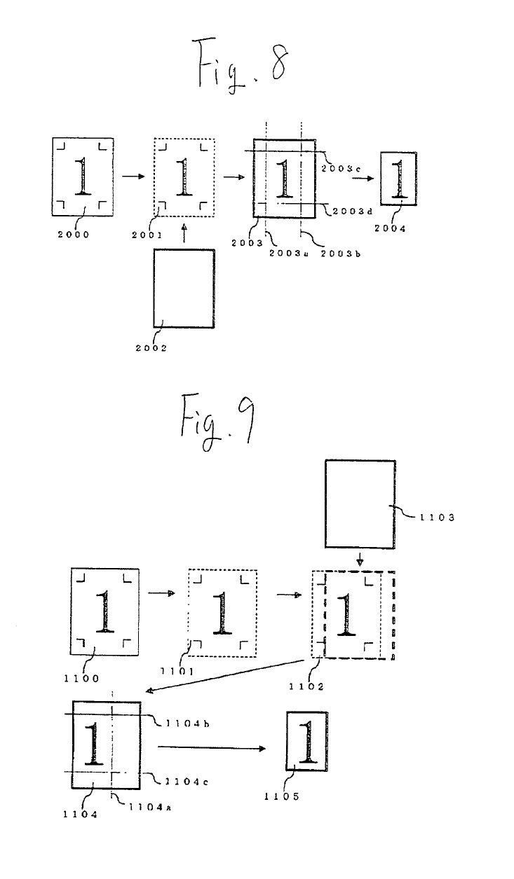

FIG. 8 is a diagram showing a procedure to form a PDL document with register marks (referred to as a register-marked PDL document), to print it, and to shape a printed sheet, by cutting, so as to have a final size. A register-marked PDL document 2000 is developed into dot image 2001 by the interpreter. Then, it is printed on a printing sheet 2002 to generate a printed sheet 2003. The four sides of the generated printed sheet 2003 are cut out along cut lines 2003a to 2003d by a cutting machine, whereby a final size of the printed sheet is generated. Thus, in the conventional technique, the PDL document and paper sizes are managed with both sizes being equal to each other, and the dot image generated by the interpreter is directly output. Accordingly, it is impossible to output the PDL document to a printing sheet of a desired size and a desired location of the printing sheet. For this reason, it is necessary to output the PDL document of the final size to the central part of the printing sheet, and then to cut out the printed sheet at four sides.

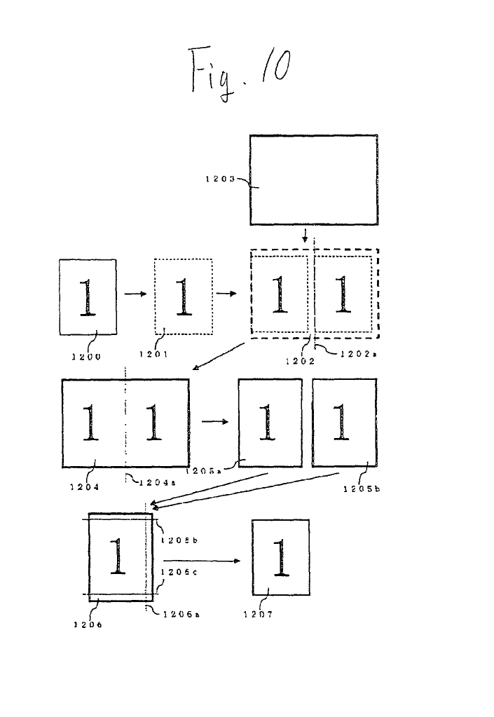

FIG. 9 is a diagram showing a procedure for generating a final size of a printed sheet by cutting the printed sheet at three sides, which the procedure is constructed according to the invention. A register-marked PDL document will be discussed as a typical example in which the adjusting shift effectively operates. A register-marked PDL document 1100 is developed into dot image 1101, and transferred to the laid-out control part 203. As described above, in the laid-out control part, it is converted into dot image, which is shifted by a shift quantity as indicated by adjustment shift 1410 from a position on the paper size 1404 designated by the paper size 1404 in FIG. 12, the position being indicated by the printing position 1408.

In a case where a document of a final size of B5, which has register marks, is output to an A4 paper 5000 of paper, as shown in FIG. 15, shift quantities on both sides of the printing are each 14 mm, which is the haft of the difference between 210 mm as the width of the A4 paper and 182 mm as the width of the B5 paper, and each of them is the adjustment shift. The dot image 1102 converted is transferred to the output control part 205, and printed on a printing sheet 1103 of paper by the printer engine 500 to generate a printed sheet 1104. The printed sheet 1104 generated is cut out at three sides along cut lines 1104a to 1104c by a cutting machine, to thereby generate a final size 1105. Thus, in the invention, the PDL document size and the sizes of the printing sheets output are separately managed. A final size of the printed sheet is generated in such a simple manner that the dot image is output to a desired location of a printing sheet of desired size, while using dot image converting means, and the printed sheet is cut out at three sides thereof. In this respect, a time taken for generating the final size is reduced.

The index label will be described hereunder. A mark as designated by numeral 6010 in FIG. 21 is used for indicating a chapter in a book or dictionary. This mark is the index label. In a printer engine system of a printer, e.g., laser printer, a print-inhibiting area 7010, as shown FIG. 22, surrounds a printing sheet 7000. No printing is permitted in the print-inhibiting area 7010.

As shown in FIG. 23, it is desired to print in such a fashion that one end of an index label 7110 is positioned at one side of the printing sheet 7100. The index label, when printed, takes a form as shown in FIG. 24, viz., a part of the index label is cut out, because of presence of the print-inhibiting area. The laid-out process of the invention is able to produce a printed sheet, which may be cut out at three sides. Accordingly, the invention is able to generate a printed sheet in which the index label is printed in a state that it is positioned at one side of the printing sheet, and to print it. Further, generally, the invention is able to generate a printed sheet not having a print-inhibiting area, and print it.

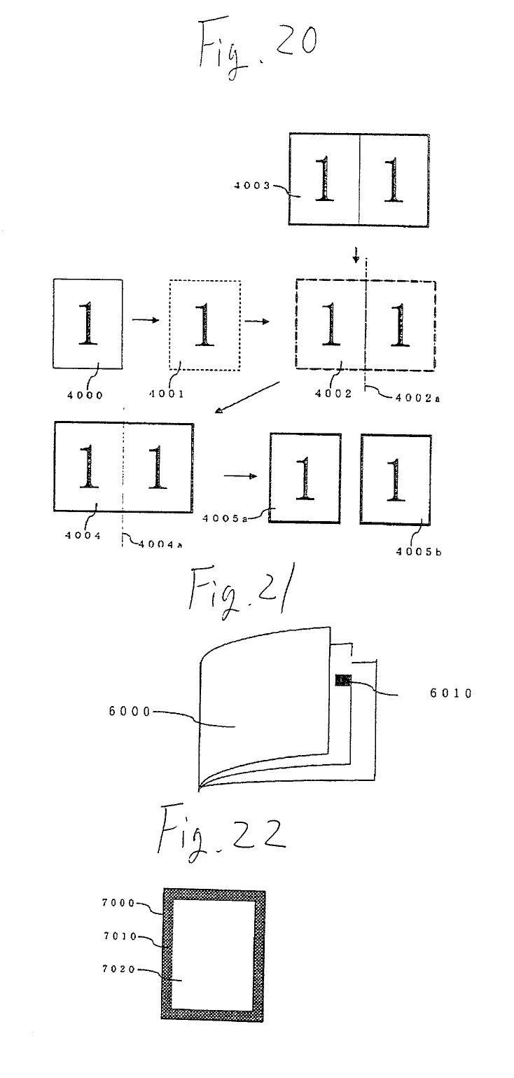

A fifth printing system in which two identical PDL documents are laid out on a sheet to generate two final sizes, will be described with reference to FIG. 20. A PDL document 4000 is developed into dot image 4001 by the interpreter, and transferred to the laid-out control part 203. When a both-side print 1413 is designated by an output type 1407 of FIG. 12, two identical dot images 4002 are juxtaposed.

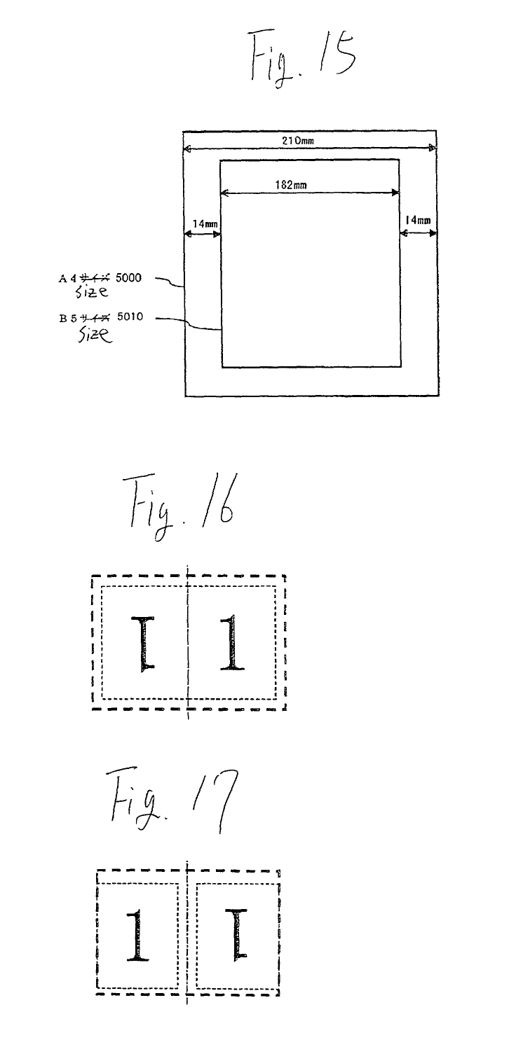

The image conversion discussed here, operates likewise in both cases where the left half part of the image is turned by 180° (FIG. 16), and where the right half part is turned by 180° (FIG. 17). The converted dot image 4002 is transferred to the output control part 205, and printed on a printing sheet 4003 by the printer engine 500, to thereby generate a printed sheet 4004. The generated printed sheet 4004 is first cut out along the center line of the sheet and along a cut line 4004a, thereby forming printed sheets 4005a and 4005b. Thus, in the invention, the PDL document size and the sizes of printing sheets output are separately managed. A final size of the printed sheet is generated in such a simple manner that the dot image is output to a desired location of a printing sheet of desired size, while using dot image converting means, and the printed sheet is cut out at three sides thereof. Therefore, two prints are produced by one printing process. In this respect, the time and labor for printing are saved. The index label will be described hereunder. A mark as designated by numeral 6010 in FIG. 21 is used for indicating a chapter in a book or dictionary. This mark is the index label. In a printer engine system of a printer, e.g., laser printer, a print-inhibiting area 7010, as shown FIG. 22, surrounds a printing sheet 7000. No printing is permitted in the print-inhibiting area 7010. As shown in FIG. 23, it is desired to print in such a fashion that one end of an index label 7110 is positioned at one side of the printing sheet 7100. The index label, when printed, takes a form as shown in FIG. 24, viz., a part of the index label is cut out, because of presence of the print-inhibiting area.

The laid-out process of the invention is able to produce a printed sheet, which may be cut out at three sides. Accordingly, the invention is able to generate a printed sheet in which the index label is printed in state that it is positioned at one side of the printing sheet, and to print it. Further, generally, the invention is able to generate a printed sheet not having a print-inhibiting area, and print it. In a normal print charging system, a tariff is determined by the number of print pages, not the size of printing sheet. Accordingly, if the both-side print is used, the tariff may be reduced to the half of that when the standard print is used.

The index label will be described hereunder. A sixth printing system in which a PDL document is laid out at two locations on a printing sheet to generate two final sizes of the printed sheets, will be described with reference to FIG. 10. A PDL document 1200 is developed into dot image 1201, and the dot image is transferred to the laid-out control part 203. When a both-side print 1413 is designated by the output type 1407 (see FIG. 12), two identical dot images 1202 are arranged side by side. Further, when the left side positioning 1414 is designated by the printing position 1408 in FIG. 12, the left hand page is shifted to the left end, and when the left hand image is shifted to the left end, and the right hand image is shifted to the center 1202a of the printing sheet. The image conversion discussed here, operates likewise in both cases where the left half part of the image is turned by 180° (FIG. 16), and where the right half part is turned by 180° (FIG. 17). The converted dot image 1202 is transferred to the output control part 205, and printed on a printing sheet 1203 by the printer engine 500, to thereby generate a printed sheet 1204. The generated printed sheet 1204 is first cut out along the center line of the sheet and along a cut line 1204a, thereby forming printed sheets 1205a and 1205b. Those printed sheets are superimposed into a printed sheet 1206. This printed sheet is cut out at three sides along cut lines 1206a to 1206c, to generate a printed sheet of a final size 1207. Thus, in the invention, the PDL document size and the sizes of printing sheets output are separately managed. A final size of the printed sheet is generated in such a simple manner that the dot image is output to a desired location of a printing sheet of desired size, while using dot image converting means, the printed sheet is cut out along the center line, and those sheets are super imposed and then cut out at three sides thereof. Therefore, two prints are produced by one printing process. In this respect, the time and labor for printing are saved.

A mark as designated by numeral 6010 in FIG. 21 is used for indicating a chapter in a book or dictionary. This mark is the index label. In a printer engine system of a printer, e.g., laser printer, a print-inhibiting area 7010, as shown FIG. 22, surrounds a printing sheet 7000. No printing is permitted in the print-inhibiting area 7010. As shown in FIG. 23, it is desired to print in such a fashion that one end of an index label 7110 is positioned at one side of the printing sheet 7100. The index label, when printed, takes a form as shown in FIG. 24, viz., a part of the index label is cut out, because of presence of the print-inhibiting area. The laid-out process of the invention is able to produce a printed sheet, which maybe cut out at three sides. Accordingly, the invention is able to generate a printed sheet in which the index label is printed in a state that it is positioned at one side of the printing sheet, and to print it. Further, generally, the invention is able to generate a printed sheet not having a print-inhibiting area, and print it. In a normal print charging system, a tariff is determined by the number of print pages, not the size of printing sheet. Accordingly, if the both-side print is used, the tariff may be reduced to the half of that when the standard print is used.

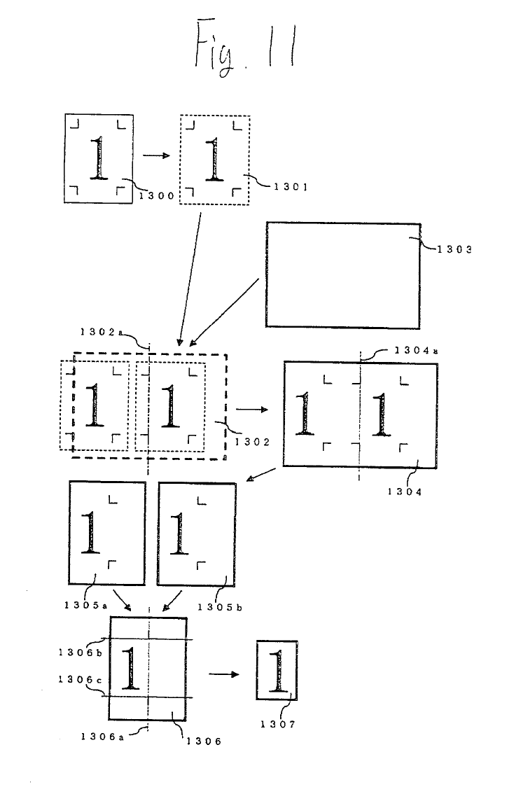

A seventh printing system in which two identical PDL documents are laid out on a page, to produce two printed sheets of a final size, will be described with reference to FIG. 11. A register-marked PDL document will be discussed as a typical example in which the adjusting shift effectively operates. A register-marked PDL document 1300 is developed into dot image 1301, and transferred to the laid-out control part 203. When a both-side print 1413 is designated by the output type 1407 (see FIG. 12), two identical dot images 1202 are arranged side by side. Further, as described above, when the left side positioning 1414 is designated by the printing position 1408 in FIG. 12, the left hand page is shifted to the left end, and when the left hand image is shifted to the left end, and the right hand image is shifted to the center 1302a of the printing sheet. Further, it is shifted by a quantity designated by the adjustment shift 1410. In a case where a document of a final size of B5, which has register marks, is output to an A4 paper 5000 of paper, as shown in FIG. 15, shift quantities on both sides of the printing sheet are each 14 mm, which is the haft of the difference between 210 mm as the width of the A4 paper and 182 mm as the width of the B5 paper, and each of them is the adjustment shift.

As in the previous case, the image conversion discussed here, operates likewise in both cases where the left half part of the image is turned by 180° (FIG. 16), and where the right half part is turned by 180° (FIG. 17). The converted dot image 1302 is transferred to the output control part 205, and printed on a printing sheet 1303 by the printer engine 500, to thereby generate a printed sheet 1304. The generated printed sheet 1304 is first cut out along the center line of the sheet and along a cut line 1204a, thereby forming printed sheets 1305a and 1305b. Those printed sheets are super imposed into a printed sheet 1306. This printed sheet is then cut out at three sides along cut lines 1306a to 1306c, to generate a printed sheet of a final size 1307. Thus, in the invention, the PDL document size and the sizes of printing sheets output are separately managed. a printed sheet of a final size is generated in such a simple manner that the dot image is output to a desired location of a printing sheet of desired size, while using dot image converting means, the printed sheet is cut out along the center line, and those sheets are superimposed and then cut out at three sides thereof. Therefore, two prints are produced by one printing process. In this respect, the time and labor for printing are saved.

The index label will be described hereunder. A mark as designated by numeral 6010 in FIG. 21 is used for indicating a chapter in a book or dictionary. This mark is the index label. In a printer engine system of a printer, e.g., laser printer, a print-inhibiting area 7010, as shown FIG. 22, surrounds a printing sheet 7000. No printing is permitted in the print-inhibiting area 7010.

As shown in FIG. 23, it is desired to print in such a fashion that one end of an index label 7110 is positioned at one side of the printing sheet 7100. The index label, when printed, takes a form as shown in FIG. 24, viz., a part of the index label is cut out, because of presence of the print-inhibiting area. The laid-out process of the invention is able to produce a printed sheet, which may be cut out at three sides. Accordingly, the invention is able to generate a printed sheet in which the index label is printed in a state that it is positioned at one side of the printing sheet, and to print it. Further, generally, the invention is able to generate a printed sheet not having a print-inhibiting area, and print it. In a normal print charging system, a tariff is determined by the number of print pages, not the size of printing sheet. Accordingly, if the both-side print is used, the tariff may be reduced to the half of that when the standard print is used.

The cutting machine, which is used in each above-mentioned embodiment, may be incorporated into the printer or separated from the latter. Manual cutting may be used in place of the cutting by the cutting machine.

What is claimed is:

1. A printer comprising:
an interpreter portion for interpreting a PDL document and developing the PDL document into dot image;
a laid-out control portion for changing the dot image in size;
an output control portion for forwarding the dot image to a printer engine; and
the printer engine for printing the dot image on a sheet.

2. The printer as defined in claim 1, wherein the laid-out control portion converts a size of the dot image to a designated sheet size

3. The printer as defined in claim 2, wherein the laid-out control portion converts the size and position of the dot image according to an instruction for designating a print position; and
the printer engine prints the dot image to a desired position on the sheet.

4. The printer as defined in claim 2, wherein, according to an instruction for positioning the dot image to one of four sides of the sheet, the laid-out control portion shifts the dot image to the one of the four sides,
wherein a final size of the document is produced by cutting the sheet at the three sides except for the one of the four sides of the sheet.

5. The printer as defined in claim 4, according to another instruction for positioning the dot image to the one of the four sides of the sheet, the laid-out control portion designates an adjustment shift and further shifts the dot image by the adjustment shift.

6. The printer as defined in claim 2, wherein the laid-out control portion controls an identical document to be laid out at two locations on the sheet,
wherein the sheet is cut out along the center line thereof to produce two final sizes of the documents.

7. The printer as defined in claim 2, wherein the laid-out control portion shifts the dot image with respect to one half portion of a printing sheet according to an instruction to lay out the document at the two locations on the sheet and an instruction for positioning the dot image to one of the four sides of the sheet;
the laid-out control portion applies a similar process to the other half portion thereof;
the printed sheet is cut out along the center line and resultant sheets are superimposed one on another; and
the those printed sheets are cut out at the three sides thereof, so that two final sizes of documents are produced.

8. The printer as defined in claim 2, wherein the laid-out control portion shifts the dot image with respect to one half portion of the sheet according to an instruction to lay out the document at two locations on the sheet and an instruction for positioning the dot image to one of the four sides of the printing sheet;
the laid-out control portion further shifts the dot image by a quantity of an adjustment shift by designating the adjustment shift with respect to the one half portion of the printing sheet;
the laid-out control portion applies a similar process to the other half portion thereof; and
the printed sheet is cut out along the center line and resultant sheets are superimposed one on the other, and the those printed sheets are cut out at the three sides thereof,
so that two final sizes of documents are produced.

9. A printer control method comprising:
receiving a PDL document;
interpreting the PDL document;
developing the PDL document into a dot image whose size is equal to the document size;
converting a size of the dot image to a designated sheet size; and
printing the dot image on a sheet.

10. The printer control method as defined in claim 9, wherein the size and position of the dot image developed is converted to those of the dot image of the designated sheet size according to an instruction for designating a print position; and
the dot image is printed to a desired position on the sheet.

11. The printer control method as defined in claim 9, further comprising:
shifting the dot image to one of the four sides of the sheet; and
cutting the resultant sheet at the three sides of the sheet except for the one of the four sides of the sheet after printing the dot image.

12. The printer control method for a printer as defined in claim 11, further comprising:
designating an adjustment shift according to an instruction for positioning the dot image to one of the four sides of the printing sheet; and
further shifting the dot image by the adjustment shift.

13. The printer control method as defined in claim 9, wherein designating an identical document to be laid out at two locations on the sheet; and
cutting the sheet along the center line thereof after the printing step.

14. The printer control method as defined in claim 9, further comprising:
shifting the dot image with respect to one half portion of the sheet according to an instruction to lay out the document at two locations on the sheet and an instruction for positioning the dot image to one of the four sides of the printing sheet;
applying a similar process to the other half portion thereof;
cutting the sheet along the center line into two resultant sheet;
superimposing the two resultant sheets one on another;
cutting the two resultant sheets at the three sides except
for the one of the four sides of the sheet.

15. The printer control method as defined in claim 14, further comprising:
designating an adjustment shift with respect to the one half portion of the printing sheet; and
shifting the dot image with respect by the quantity of the adjustment shift.
